(19) United States
(12) Patent Application Publication
(10) Pub. No.: US 2009/0239043 A1
(43) Pub. Date: Sep. 24, 2009

(54) OLEOPHILIC COMPOSITIONS, COATINGS EMPLOYING THE SAME, AND DEVICES FORMED THEREFROM

(75) Inventors: Constantine A. Kondos, Pittsburgh, PA (US); Shan Cheng, Sewickley, PA (US); Charles M. Kania, Natrona Heights, PA (US); Cheri M. Boykin, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/053,858

(22) Filed: Mar. 24, 2008

(51) Int. Cl. B32B 9/04; B32B 17/06; B32B 15/04; B32B 27/06; C09D 4/00; C09D 133/00

(52) U.S. Cl. 428/195.1; 428/411.1; 428/426; 428/457; 428/480; 428/450; 106/285; 524/556

(57) ABSTRACT

Oleophilic compositions, coatings employing the same, and devices formed therefrom that exhibit one or more improved coating properties. The compositions may comprise a film-forming binder and, when at least partially coated and cured on a substrate, comprise: (a) a contact angle with water ranging from 50 to less than 78; and (b) a contact angle with squalene of less than 25. The coating compositions may include various binder compositions, including, for example, thermosetting acrylic polymers, thermoplastic acrylic polymers, radiation curable coating compositions, and alkoxide compositions. The resultant coatings exhibit one or more improved physical properties, such as improved gloss, improved stain and sebum resistance, and/or improved cleaning ability relative to existing coating systems when deposited over various substrates.

### FIELD

The present disclosure is directed to oleophilic compositions, coatings employing the same, and devices formed therefrom that exhibit improved coating properties, such as fingerprint stain resistance.

### BACKGROUND

Coating formulations and their application over various substrates find use in numerous industries, such as, for example, in industries employing optics and coated electronic displays. In these industries, considerable efforts have been made to develop coating compositions that provide manufacturing advantages, improved coating properties, and/or improved surface appearance. In the optics and display manufacturing industry, for example, numerous techniques have been advanced to achieve manufacturing efficiencies, such as reduced coating times and costs, and/or improved properties, such as improved coating appearance and fingerprint stain resistance, while still providing protection to the underlying substrate. These efforts have resulted in the development of various waterborne or solvent-based coating formulations, or techniques to deposit these coating compositions over various substrates.

For example, numerous coating systems have been developed that fall within strict formulation parameters such that when deposited over a substrate to form a film, are said to exhibit certain improved physical properties. Published Japanese Patent Application No. 2004-359834 to Mitsubishi Chemical Corporation discloses one such coating system. The Mitsubishi reference teaches specific compositions that, when cured, form a coating that provides contact angles of water of 80 degrees or greater and which are said to improve fingerprint and sebum stain resistance, as well as exhibit excellent hardness, scratch resistance, transparency, and low curing.

It has been found that a wide variety of factors may be important in formulating coating systems and their related methods that influence the overall appearance of the coated device. For example, it has been found that each component of the coating system, the interaction between or among components when combined, the amounts used, the manufacturing conditions employed, and the like, can all lead to significantly different and varied coating properties, particularly when applied to different substrates or complex surface contours and configurations.

Accordingly, the need exists for coating systems having formulations and improved manufacturing methods wherein the resultant coatings exhibit one or more improved physical properties, such as improved gloss, improved stain and sebum resistance, and/or improved cleaning ability relative to existing coating systems when deposited over various substrates.

### SUMMARY

Disclosed herein are various non-limiting embodiments generally directed to oleophilic compositions, coatings employing the same, and devices formed therefrom.

In one embodiment, the present disclosure provides a coating composition comprising a film-forming binder and, when at least partially coated and cured on a substrate, comprises (a) a contact angle with water ranging from 50 to less than 78, and (b) a contact angle with squalene of less than 25.

In another embodiment, the present disclosure is directed to a film-forming coating composition, comprising a film-forming binder formed from at least one of a blend of components and reactants. The film-forming binder comprises at least one alkyl methacrylate having from 1 to 20 carbon atoms in the alkyl group present in an amount of at least 20 percent by weight, based on the total weight of the coating composition, and at least one (meth)acrylate with polycycloalkyl groups or alkyl groups having 10 or more carbons present in the composition in an amount of at least 5 percent by weight, based on the total weight of the coating composition. When at least partially coated and cured on a substrate, the coating composition comprises (a) a contact angle with water ranging from 50 to less than 78, and (b) a contact angle with squalene of less than 25.

In another embodiment, the present disclosure provides a thermosetting acrylic polymer coating composition, comprising a film-forming binder having functional groups and formed from reactants, and a crosslinking agent having functional groups capable of reacting with the functional groups of the binder. The film-forming binder comprises at least one alkyl methacrylate having from 1 to 20 carbon atoms in the alkyl group present in an amount ranging from 10 to 40 percent by weight, based on the total weight of the acrylic polymer, and at least one (meth)acrylate with polycycloalkyl groups or alkyl groups having 10 or more carbons present in the composition in an amount ranging from 30 to 65 percent by weight, based on the total weight of the acrylic polymer.

In yet another embodiment, the present disclosure provides a high molecular weight thermoplastic acrylic polymer coating composition, comprising a film-forming binder formed from reactants. The reactants comprise at least one of alkyl methacrylate having from 1 to 20 carbon atoms in the alkyl group present in an amount of at least 20 by weight, based on the total weight of the acrylic polymer, and at least one (meth)acrylate with polycycloalkyl groups or alkyl groups having 10 or more carbons present in the composition in an amount ranging from 40 to 70 percent by weight, based on the total weight of the acrylic polymer.

In another embodiment, the present disclosure is directed to a radiation curable coating composition formed in the presence of monomeric components, comprising at least one (meth)acrylate with polycycloalkyl groups or alkyl groups having 10 or more carbons present in the composition in an amount of at least 5 percent by weight, based on the total weight of the coating composition, at least one of one multifunctional acrylate, and a radiation cure initiator.

Also provided is a device comprising a substrate that comprises at least one coating layer, the at least one coating layer formed from a coating composition. The coating composition comprises an alkoxide of the general formula RₓM(OR′)_{z-x}, where R is an organic radical, M is selected from the group consisting of silicon, aluminum, titanium, zirconium and mixtures of any thereof, R′ is selected from the group consisting of low molecular weight alkyl radicals, z is the valence of M, and x is less than z and may be zero except when M is silicon. When at least partially coated and cured on the substrate, the coating composition comprises a contact angle with squalene of ≦20.

It should be understood that this invention is not limited to the embodiments disclosed in this Summary, and it is intended to cover modifications that are within the spirit and scope of the invention, as defined by the claims.

### BRIEF DESCRIPTION OF THE DRAWING

The characteristics and advantages of the present invention may be better understood by reference to the accompanying drawing in which:

FIG. 1 is a graphic illustration of the percent haze of various embodiments of the present disclosure relative to conventional compositions.

### DETAILED DESCRIPTION

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mn”) or weight average molecular weight (“Mw”)), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used. The terms “one,” “a,” or “an” as used herein are intended to include “at least one” or “one or more,” unless otherwise indicated.

As used herein, the term “polymer” is meant to refer to oligomers and both homopolymers and copolymers.

Also for molecular weights, whether Mn or Mw, these quantities are determined by gel permeation chromatography using polystyrene as standards as is well known to those skilled in the art and such as is discussed in U.S. Pat. No. 4,739,019 at column 4, lines 2-45, which is incorporated herein by reference in its entirety.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used herein, phrases such as “based on the total weight of resin solids,” “based on the total weight of the acrylic polymer,” and the like, when referring to a coating composition, means that the amount of the component added during the formation of the composition is based upon the total weight of the resin solids (non-volatiles) of the film forming materials present during the formation of the composition, but not including any water, solvent, or any additive solids such as hindered amine stabilizers, photoinitiators, colorants, including extender pigments and fillers, flow modifiers, catalysts, and UV light absorbers.

As used herein, “formed from” denotes open, e.g., “comprising,” claim language. As such, it is intended that a composition “formed from” a list of recited components be a composition comprising at least these recited components, and can further comprise other nonrecited components during the composition's formation.

As used herein, the term “cure” as used in connection with a composition, e.g., “a cured composition” shall mean that any crosslinkable components of the composition are at least partially crosslinked. In certain embodiments of the present disclosure, the crosslink density of the crosslinkable components, i.e., the degree of crosslinking, ranges from 5% to 100% of complete crosslinking. In other embodiments, the crosslink density ranges from 35% to 85% of full crosslinking. In other embodiments, the crosslink density ranges from 50% to 85% of full crosslinking. One skilled in the art will understand that the presence and degree of crosslinking, i.e., the crosslink density, can be determined by a variety of methods, such as dynamic mechanical thermal analysis (DMTA) using a TA Instruments DMA 2980 DMTA analyzer conducted under nitrogen. This method determines the glass transition temperature and crosslink density of free films of coatings or polymers. These physical properties of a cured material are related to the structure of the crosslinked network.

As used herein, “thin film” refers to a film having a dry film thickness of less than 200 microns, typically less than 100 microns, in some embodiments within the range of 3 to 50 microns, and in other embodiments within the range of 5 to 35 microns. As used herein, the phrase “film-forming material” refers to a material that by itself or in combination with a coreactive material, such as a crosslinking agent, is capable of forming a continuous film on a surface of a substrate.

Embodiments of the present disclosure provide coating compositions, substrates, and devices having one or more layers formed from the oleophilic compositions set forth herein. In one embodiment, the coating composition may comprise a firm-forming binder that when at least partially coated and cured on a substrate form a thin film coating layer having particularly beneficial coating properties. For example, in certain embodiments, the coating composition, when deposited and treated to form a cured coating, may be characterized as comprising a contact angle with water ranging from 50 to less than 78, and a contact angle with squalene of less than 25. As will be discussed below, coating compositions exhibiting contact angles of water and squalene within these ranges have been found to display certain advantages over conventional coating layers.

It has been found that the coating compositions having beneficial performance properties may include various binder compositions, including, for example, thermosetting acrylic polymers, thermoplastic acrylic polymers, radiation curable coating compositions, and alkoxide compositions, as set forth hereinbelow.

In one embodiment, the present disclosure provides a thermosetting acrylic polymer coating composition, comprising a film-forming binder having functional groups and formed from reactants, and may comprise, for example, at least one alkyl methacrylate having from 1 to 20 carbon atoms in the alkyl group, at least one (meth)acrylate with polycycloalkyl groups or alkyl groups having 10 or more carbons, and a crosslinking agent having functional groups capable of reacting with the functional groups of the binder. As used herein, “(meth)acrylate” and terms derived therefrom are intended to include both acrylates and methacrylates.

The at least one alkyl methacrylate may have from 1 to 20 carbon atoms, and in certain embodiments may have from 1 to 12 carbon atoms, in the alkyl group. Various alkyl methacrylate compounds known to those of ordinary skill in the art may be employed in the binder composition, such as, for example, methacrylate, ethyl methacrylate, propyl methacrylate, isopropyl methacrylate, butyl methacrylate, isobutyl methacrylate, tert-butyl methacrylate, 2-ethylhexyl methacrylate, lauryl methacrylate, cyclohexyl methacrylate, 3,3,5-trimethylcyclohexyl methacrylate, hydroxyalkyl methacrylates, such as hydroxypropyl methacrylate, oxirane functional methacrylates, carboxylic acid functional methacrylates, and combinations of any thereof.

The at least one alkyl methacrylate may be present in the thermosetting acrylic polymer in any suitable amount, and may be present in an amount ranging from 10 to 40 percent by weight, based on the total weight of the acrylic polymer. In certain embodiments, the alkyl methacrylate may be present in the acrylic polymer in amounts ranging from 20 to 30 percent by weight, and in still other embodiments in amounts of 25 percent by weight, based on the total weight of the acrylic polymer. The amount of alkyl methacrylate present in the thermosetting acrylic polymer can range between any combination of these values inclusive of the recited values.

The binder of the thermosetting acrylic polymer may further comprise at least one (meth)acrylate with polycycloalkyl groups or alkyl groups having 10 or more carbons. Suitable compounds include, for example, decyl(meth)acrylate, dodecyl(meth)acrylate, stearyl (meth)acrylate, behenyl (meth)acrylate, tricyclodecene monomethanol mono(meth)acrylate, isobornyl acrylate, and isobornyl methacrylate.

The at least one (meth)acrylate with polycycloalkyl groups or alkyl groups may be present in the thermosetting acrylic polymer in various amounts, and may be present in an amount of at least 5 percent by weight, based on the total weight of the acrylic polymer. In certain embodiments, the at least one (meth)acrylate with polycycloalkyl groups or alkyl groups may be present in amounts ranging from 30 to 65 percent by weight, and in other embodiments may be present in amounts ranging from 45 to 55 percent, based on the total weight of the acrylic polymer. The amount of (meth)acrylate with polycycloalkyl groups or alkyl groups present in the thermosetting acrylic polymer can range between any combination of these values inclusive of the recited values.

In one embodiment of the present disclosure, the acrylic polymer binder may comprise hydroxyl and/or carbamate functional groups. Hydroxyl and/or carbamate functional group-containing acrylic polymers and/or polyester polymers may also be suitable for use.

For example, the acrylic polymer may contain hydroxyl functionality which can be incorporated into the polymer through the use of hydroxyl functional monomers such as hydroxyethyl (meth)acrylate and hydroxypropyl (meth)acrylate which may be copolymerized with the other acrylic monomers set forth herein.

The hydroxyl group-containing acrylic polymers useful in the compositions of the present disclosure can have a hydroxyl value ranging from 10 to 150, usually from 15 to 90, and typically from 20 to 50.

Pendent and/or terminal carbamate functional groups can be incorporated into the acrylic polymer by copolymerizing the acrylic monomer with a carbamate functional vinyl monomer, such as a carbamate functional alkyl ester of methacrylic acid. These carbamate functional alkyl esters may be prepared by reacting, for example, a hydroxyalkyl carbamate, such as the reaction product of ammonia and ethylene carbonate or propylene carbonate, with methacrylic anhydride. Other carbamate functional vinyl monomers can include the reaction product of hydroxyethyl methacrylate, isophorone diisocyanate and hydroxypropyl carbamate. Still other carbamate functional vinyl monomers may be used, such as the reaction product of isocyanic acid (HNCO) with a hydroxyl functional acrylic or methacrylic monomer such as hydroxyethyl acrylate, and those carbamate functional vinyl monomers described in U.S. Pat. No. 3,479,328, which is incorporated herein by reference in its entirety.

Carbamate groups can also be incorporated into the acrylic polymer by a “transcarbamoylation” reaction in which a hydroxyl functional acrylic polymer is reacted with a low molecular weight carbamate derived from an alcohol or a glycol ether. The carbamate groups can exchange with the hydroxyl groups yielding the carbamate functional acrylic polymer and the original alcohol or glycol ether.

The low molecular weight carbamate functional material derived from an alcohol or glycol ether may be first prepared by reacting the alcohol or glycol ether with urea in the presence of a catalyst such as butyl stannoic acid. Suitable alcohols include lower molecular weight aliphatic, cycloaliphatic and aromatic alcohols, such as methanol, ethanol, propanol, butanol, cyclohexanol, 2-ethylhexanol and 3-methylbutanol. Suitable glycol ethers include ethylene glycol methyl ether and propylene glycol methyl ether.

Also, hydroxyl functional acrylic polymers can be reacted with isocyanic acid yielding pendent carbamate groups. Note that the production of isocyanic acid is disclosed in U.S. Pat. No. 4,364,913, which is incorporated by reference herein it its entirety. Likewise, hydroxyl functional acrylic polymers can be reacted with urea to give an acrylic polymer with pendent carbamate groups.

The thermosetting acrylic polymer coating composition may further comprise a crosslinking agent having functional groups capable of reacting with the functional groups of the acrylic binder. Various crosslinking agents known to those of ordinary skill in the art may be employed in the thermosetting acrylic polymer coating composition of the present disclosure. For example, the functional groups may be any suitable functional groups, including, but are not limited to, epoxy or oxirane, carboxylic acid, hydroxy, polyol, isocyanate, capped isocyanate, amine, methylol, methylol ether, aminoplast and beta-hydroxyalkylamide.

A non-limiting example of the present thermosetting composition is one where the functional group of the binder is hydroxy and the functional group of the crosslinking agent is a capped polyisocyanate, where the capping group of the capped polyisocyanate crosslinking agent is one or more of hydroxy functional compounds, 1H-azoles, lactams, ketoximes, and mixtures thereof. The capping group may be phenol, p-hydroxy methylbenzoate, 1H-1,2,4-triazole, 1H-2,5-dimethylpyrazole, 2-propanone oxime, 2-butanone oxime, cyclohexanone oxime, e-caprolactam, or mixtures thereof. The polyisocyanate of the capped polyisocyanate crosslinking agent may be one or more of 1,6-hexamethylene diisocyanate, cyclohexane diisocyanate, alpha, alpha′-xylylene diisocyanate, alpha, alpha, alpha′, alpha′-tetramethylxylylene diisocyanate, 1-isocyanato-3,3,5-trimethyl-5-isocyanatomethylcyclohexane, diisocyanato-dicyclohexylmethane, dimers of the polyisocyanates, or trimers of the polyisocyanates.

One or more crosslinking agents may be employed in the composition at various amounts, such as, for example, in amounts ranging from 5 to 55 percent by weight, and in some embodiments in amounts ranging from 35 to 45 percent by weight, based on the total weight of the acrylic polymer. The amount of crosslinking agent present in the thermosetting acrylic polymer can range between any combination of these values inclusive of the recited values.

In another embodiment, the present disclosure provides a thermoplastic acrylic polymer, such as a high molecular weight thermoplastic acrylic polymer, comprising a film-forming binder formed from reactants. The reactants may comprise at least one of alkyl methacrylate having from 1 to 20 carbon atoms in the alkyl group, and at least one (meth)acrylate with polycycloalkyl groups or alkyl groups having 10 or more carbons.

The at least one alkyl methacrylate may include any of those alkyl methacrylates set forth herein and may have from 1 to 20 carbon atoms, and in certain embodiments may have from 1 to 12 carbon atoms, in the alkyl group. Like the alkyl methacrylates of the thermosetting acrylic polymer, the alkyl methacrylates that may be employed in the thermoplastic acrylic polymer may be any suitable component known to those of ordinary skill in the art, such as for example, methacrylate, ethyl methacrylate, propyl methacrylate, isopropyl methacrylate, butyl methacrylate, isobutyl methacrylate, tert-butyl methacrylate, 2-ethylhexyl methacrylate, lauryl methacrylate, cyclohexyl methacrylate, 3,3,5-trimethylcyclohexyl methacrylate, hydroxyalkyl methacrylates, such as hydroxypropyl methacrylate, oxirane functional methacrylates, and carboxylic acid functional methacrylates.

The at least one alkyl methacrylate having from 1 to 20 carbon atoms in the alkyl group may be present in the film-forming binder of the thermoplastic acrylic polymer in any suitable amount. For example, the at least one alkyl methacrylate may be present in the film-forming binder in amounts ranging from at least 20 percent by weight, based on the total weight of the acrylic polymer, and may be present in amounts of at least 20 to 30 percent by weight, based on the total weight of the acrylic polymer. The amount of alkyl methacrylate present in the thermoplastic acrylic polymer can range between any combination of these values inclusive of the recited values.

The binder of the thermoplastic acrylic polymer may further comprise at least one (meth)acrylate with polycycloalkyl groups or alkyl groups having 10 or more carbons. Like the thermosetting acrylic polymer set forth herein, suitable binder components include, for example, decyl(meth)acrylate, dodecyl(meth)acrylate, stearyl (meth)acrylate, behenyl (meth)acrylate, tricyclodecene monomethanol mono(meth)acrylate, isobornyl acrylate, and isobornyl methacrylate.

The at least one (meth)acrylate with polycycloalkyl groups or alkyl groups may be present in the thermoplastic acrylic polymer in any suitable amount, and may be present in an amount ranging from 40 to 70 percent by weight, based on the total weight of the acrylic polymer. In certain embodiments, the at least one (meth)acrylate with polycycloalkyl groups or alkyl groups may be present in the acrylic polymer in amounts ranging from 45 to 65 percent by weight, based on the total weight of the acrylic polymer. The amount of (meth)acrylate with polycycloalkyl groups or alkyl groups present in the thermoplastic polymer can range between any combination of these values inclusive of the recited values.

In certain embodiments, the thermoplastic acrylic polymer is a high molecular weight polymer wherein Mw of the thermoplastic acrylic polymer is greater than 8,000. In other embodiments Mw of the thermoplastic acrylic polymer may range from 10,000 to 30,000.

In another embodiment, the present disclosure provides a radiation curable coating composition formed in the presence of monomeric components, comprising at least one (meth)acrylate with polycycloalkyl groups or alkyl groups having 10 or more carbons present in the composition in an amount of at least 5 percent by weight, based on the total weight of the resin solids, at least one of one multifunctional acrylate, and a radiation cure initiator. The monomeric components may be blended into a radiation curable mixture for deposition onto a substrate such that the components form a reaction product upon radiation cure, as set forth below.

The at least one (meth)acrylate with polycycloalkyl groups or alkyl groups having 10 or more carbons may be any of the (meth)acrylate substituents set forth herein. For example, like the thermosetting acrylic polymer set forth herein, suitable (meth)acrylate with polycycloalkyl groups or alkyl groups having 10 or more carbons include, for example, decyl(meth)acrylate, dodecyl(meth)acrylate, stearyl (meth)acrylate, behenyl (meth)acrylate, tricyclodecene monomethanol mono(meth)acrylate, isobornyl acrylate, and isobornyl methacrylate.

The at least one (meth)acrylate with polycycloalkyl groups or alkyl groups may be present in the radiation curable coating composition in any suitable amount, and may be present in an amount of at least 5 percent by weight, based on the total weight of the resin solids. In certain embodiments, the at least one (meth)acrylate with polycycloalkyl groups or alkyl groups may be present in the radiation curable coating composition in amounts ranging from 20 to 30 percent by weight, based on the total weight of the resin solids. The amount of (meth)acrylate with polycycloalkyl groups or alkyl groups present in the radiation curable compositions can range between any combination of these values inclusive of the recited values.

The radiation curable coating composition may further comprise at least one multi-functional acrylate. As used herein, the term “multi-functional acrylate” refers to monomers or oligomers having an acrylate functionality of greater than 1.0, such as at least 2.0. Multifunctional acrylates suitable for use in the compositions of the present disclosure include, for example, those that have a relative molar mass of from 170 to 5000 grams per mole, such as 170 to 1500 grams per mole. In the compositions of the present disclosure, the multi-functional acrylate may act as a reactive diluent that is radiation curable. Upon exposure to radiation, a radical induced polymerization of the multi-functional acrylate with monomer or oligomer is induced, thereby incorporating the reactive diluent into the coating matrix.

Multi-functional acrylates suitable for use in the radiation curable compositions of the present disclosure may include, without limitation, difunctional, trifunctional, tetrafunctional, pentafunctional, hexafunctional (meth)acrylates and mixtures thereof.

Representative examples of suitable multi-functional acrylates include, without limitation, ethylene glycol di(meth)acrylate, 1,3-butylene glycol di(meth)acrylate, 1,4-butanediol diacrylate, 2,3-dimethylpropane 1,3-diacrylate, 1,6-hexanediol di(meth)acrylate, dipropylene glycol diacrylate, ethoxylated hexanediol di(meth)acrylate, propoxylated hexanediol di(meth)acrylate, neopentyl glycol di(meth)acrylate, alkoxylated neopentyl glycol di(meth)acrylate, hexylene glycol di(meth)acrylate, diethylene glycol di(meth)acrylate, tripropylene glycol di(meth)acrylate, thiodiethyleneglycol diacrylate, trimethylene glycol dimethacrylate, pentaerythritol tri(meth)acrylate, trimethylolpropane tri(meth)acrylate, ditrimethylolpropane tetra(meth)acrylate, glycerolpropoxy tri(meth)acrylate, ethoxylated trimethylolpropane tri(meth)acrylate, and tetraethylene glycol di(meth)acrylate, including mixtures thereof.

In certain embodiments, the radiation curable compositions of the present disclosure may comprise less than 90 percent by weight of multi-functional acrylate or, in some embodiments, less than 85 percent by weight or, in yet other embodiments, more than 20 percent by weight up to less than 80 percent by weight, or, in still other embodiments, from 35 up to 65 percent by weight of multi-functional acrylate based on the total weight of the resin solids. The amount of multifunctional acrylate present in the radiation curable compositions can range between any combination of these values inclusive of the recited values.

In certain embodiments, the radiation curable composition may comprise a radiation cure initiator. Useful radiation-curable groups which can be present as reactive functional groups include unsaturated groups such as vinyl groups, acrylate groups, methacrylate groups, ethacrylate groups, epoxy groups such as cycloaliphatic epoxy groups. In one embodiment, the radiation curable group may be UV curable and can include acrylate groups, maleimides, fumarates, and vinyl ethers. Compositions such as those provided in U.S. Pat. No. 7,053,149, incorporated by reference herein in its entirety, provide suitable radiation curable coating compositions for use in the present disclosure. In embodiments where the radiation curable composition is to be cured by UV radiation, the compositions of the present disclosure may comprise a photoinitiator. As will be appreciated by those skilled in the art, a photoinitiator absorbs radiation during cure and transforms it into chemical energy available for the polymerization. Photoinitiators are classified in two major groups based upon a mode of action, either or both of which may be used in the compositions of the present disclosure. Cleavage-type photoinitiators include acetophenones, α-aminoalkylphenones, benzoin ethers, benzoyl oximes, acylphosphine oxides and bisacylphosphine oxides and mixtures thereof. Abstraction-type photoinitiators include benzophenone, Michler's ketone, thioxanthone, anthraquinone, camphorquinone, fluorone, ketocoumarin and mixtures thereof. Other examples of photoinitiators and photosensitizers can be found in U.S. Pat. No. 4,017,652, incorporated by reference herein in its entirety. radiation cure initiator or group.

Specific nonlimiting examples of photoinitiators that may be used in the radiation curable compositions of the present disclosure include benzil, benzoin, benzoin methyl ether, benzoin isobutyl ether benzophenol, acetophenone, benzophenone, 4,4′-dichlorobenzophenone, 4,4′-bis(N,N′-dimethylamino)benzophenone, diethoxyacetophenone, fluorones, e.g., the H—Nu series of initiators available from Spectra Group Ltd., 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, e.g., 2,6-dimethylbenzoyldlphenyl phosphine oxide, 2,4,6-trimethylbenzoyldiphenylphosphine oxide, bis(2,4,6-trimethylbenzoyl)phenyl phosphine oxide, 2,6-dichlorobenzoyl-diphenylphosphine oxide, and 2,6-dimethoxybenzoyldiphenylphosphine oxide, bisacylphosphine oxides, e.g., bis(2,6-dimethyoxybenzoyl)-2,4,4-trimethylepentylphosphine oxide, bis(2,6-dimethylbenzoyl)-2,4,4-trimethylpentylphosphine oxide, bis(2,4,6-trimethylbenzoyl)-2,4,4-trimethylpentylphosphine oxide, and bis(2,6-dichlorobenzoyl)-2,4,4-trimethylpentylphosphine oxide, and mixtures thereof.

In certain embodiments, the radiation curable compositions of the present disclosure may comprise 0.01 up to 15 percent by weight of photoinitiator or, in some embodiments, 0.01 up to 10 percent by weight, or, in yet other embodiments, 0.01 up to 5 percent by weight of photoinitiator. The amount of photoinitiator present in the radiation curable compositions can range between any combination of these values inclusive of the recited values.

The radiation curable coating composition may have varied solids amounts based on the desired application and treatment. For example, in certain embodiments, the radiation curable coating composition may comprise at least 30% by weight solids, in certain embodiments may comprise at least 50% by weight solids, in other embodiments may comprise between 50 to 60% by weight solids.

In another embodiment, the present disclosure provides a coating composition that is an alkoxide of the general formula RₓM(OR′)_{z-x}, where R is an organic radical, M is selected from the group consisting of silicon, aluminum, titanium, zirconium and mixtures of any thereof, R′ is selected from the group consisting of low molecular weight alkyl radicals, z is the valence of M, and x is less than z and may be zero except when M is silicon wherein, when at least partially coated and cured on substrate, the coating composition comprises a contact angle with squalene of less than or equal to 20. Examples of suitable organic radicals include, but are not limited to, alkyl, vinyl, methoxyalkyl, phenyl, γ-glycidoxy propyl and γ-methacryloxy propyl. The alkoxide can be further mixed and/or reacted with other compounds and/or polymers known in the art. Particularly suitable are compositions comprising siloxanes formed from at least partially hydrolyzing an organoalkoxysilane, such as one within the formula above. Examples of suitable alkoxide-containing compounds and methods for making them are described in U.S. Pat. Nos. 6,355,189; 6,264,859; 6,469,119; 6,180,248; 5,916,686; 5,401,579; 4,799,963; 5,344,712; 4,731,264; 4,753,827; 4,754,012; 4,814,017; 5,115,023; 5,035,745; 5,231,156; 5,199,979; and 6,106,605, all of which are incorporated by reference herein.

In certain embodiments, the alkoxide may comprise a combination of a glycidoxy[(C₁-C₃)alkyl]tri(C₁-C₄)alkoxysilane monomer and a tetra(C₁-C₆)alkoxysilane monomer. Glycidoxy[(C₁-C₃)alkyl]tri(C₁-C₄)alkoxysilane monomers suitable for use in the coating compositions of the present disclosure include glycidoxymethyltriethoxysilane, α-glycidoxyethyltrimethoxysilane, α-glycidoxyethyl-triethoxysilane, β-glycidoxyethyltrimethoxysi lane, β-glycidoxyethyl-triethoxysilane, α-glycidoxy-propyltrimethoxysilane, α-glycidoxypropyltriethoxysilane, β-glycidoxypropyltrimethoxysilane, β-glycidoxypropyltriethoxysilane, γ-glycidoxypropyltrimethoxysilane, hydrolyzates thereof, or mixtures of such silane monomers.

Suitable tetra (C₁-C₆)alkoxysilanes that may be used in combination with the glycidoxy[(C₁-C₃)alkyl]tri(C₁-C₄)alkoxysilane in the coating compositions of the present disclosure include, for example, materials such as tetramethoxysilane, tetraethoxysilane, tetrapropoxysilane, tetrabutoxysilane, tetrapentyloxysilane, tetrahexyloxysilane, and mixtures of any thereof.

In certain embodiments, the glycidoxy[(C₁-C₃)alkyl]tri(C₁-C₄)alkoxysilane and tetra(C₁-C₆)alkoxysilane monomers used in the coating composition of the present disclosure are present in a weight ratio of glycidoxy [(C₁-C₃)alkyl]tri(C₁-C₄)alkoxysilane to tetra(C₁-C₆)alkoxysilane of from 0.5:1 to 100:1, such as 0.75:1 to 50:1 and, in some cases, from 1:1 to 5:1.

In certain embodiments, the alkoxide (or combination of two or more thereof described above) is present in the coating composition in an amount of 5 to 75 percent by weight, such as 10 to 70 percent by weight, or, in some cases, 20 to 65 percent by weight, or, in yet other cases, 25 to 60 percent by weight, with the weight percent being based on the total weight of the resin solids.

Alkoxide coating compositions, such as siloxane-containing coating formulations, may be obtained by hydrolysis and condensation of silane compounds, and are generally commercially known as sol-gels.

In this embodiment, it has been found that alkoxides as set forth herein that are substantially free of silicon additives provide particularly beneficial surface coating properties as set forth below. As used herein, the term “substantially free” means that the material is present in the composition, if at all, as an incidental impurity. In other words, the material is not intentionally added to the composition, but may be present at minor or inconsequential levels, because it was carried over as an impurity as part of an intended composition component. In certain embodiments, for example, silicon may be present in the compositions of the present disclosure in an amount of less than 0.1 percent by weight or, in some cases, less than 0.05 percent by weight, and, in yet other embodiments, less than 0.01 percent by weight. In some embodiments, for example, the compositions of the present disclosure are free of silicon.

Other ingredients such as colorants and fillers can be present in embodiments of the coating compositions set forth herein. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present disclosure, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in any amount sufficient to impart the desired visual and/or color effect. Various amounts of useful fillers, including barium sulfate, magnesium silicate, calcium carbonate, and silica, may also be employed. Colorants and fillers can be present in amounts of up to 60 parts by weight or less based on 100 parts by weight of total solids of the coating composition.

Other optional ingredients can include anti-oxidants, UV-absorbers and hindered amine light stabilizers, such as for example, hindered phenols, benzophenones, benzotriazoles, triazoles, triazines, benzoates, piperidinyl compounds and mixtures thereof. These ingredients are typically added in amounts up to 2 percent based on the total weight of resin solids of the composition. Other optional ingredients include water miscible materials, reactive diluents, co-solvents, coalescing aids, defoamers, plasticizers, associative thickeners, bactericides and the like. The coating compositions of the present disclosure may also contain a solvent such as conventional aliphatic and aromatic solvents or diluents known in the art.

It is contemplated that depending upon the desired application and intended use, the coating compositions of the present disclosure may be incorporated into various coating compositions. For example, the coating compositions set forth herein may be incorporated into various conventional coating compositions, such as SPECTRACRON, SOLGARD, HI-GARD, DURETHANE, and RAYCRON coating compositions, commercially available from PPG Industries, Inc., Pittsburgh Pa. As described hereinbelow, the percent solids of the coating composition and the thickness of the coating composition as applied to the substrate can vary based upon various factors, such as the particular type of coating that is formed from the coating composition, i.e. whether the coating composition is used in a primer, a basecoat, a topcoat, a clearcoat, or combinations thereof, or as a monocoat composition; and the type of substrate and intended end use of the substrate. In certain embodiments of the present disclosure, the coating composition may comprise the thermosetting acrylic polymer, the high molecular weight thermoplastic polymer, the radiation curable composition, or the alkoxide coating composition, as set forth herein.

In addition, it is contemplated that the coating composition of the present disclosure may be used to form a multilayer composite coating for application over a substrate including any of those substrates set forth herein. For example, embodiments of the present disclosure contemplate that compositions set forth herein may be employed in at least one layer of a multilayer composite coating. When a crosslinking agent is employed in embodiments of the present disclosure, the crosslinking agent may be reactive with the functional groups of the film-forming component. The crosslinking agent may also be capable of self-crosslinking, i.e., it contains reactive groups that are capable of reacting with each other to form a crosslinked network.

To achieve improved fingerprint and sebum resistance and gloss properties on the coated substrate, the film forming component may be curable or thermosettable as provided hereinbelow. The film-forming material may be self-crosslinking, although external crosslinking agents can be used.

Any suitable coating composition set forth herein may be deposited over the various substrates of the present disclosure. The coating compositions of the present disclosure may be deposited on any suitable substrate in any manner known to those of ordinary skill in the art. As used herein, the phrase “deposited on” or “deposited over” a substrate, and like terms, means deposited or provided above or over but not necessarily adjacent to the surface of the substrate. For example, a coating can be deposited directly on the substrate or one or more other coatings can be applied therebetween. In certain embodiments, the coating compositions may be sprayable over the substrate. As used herein, the term “sprayable” refers to compositions that are capable of being applied uniformly by atomization through a device such as a spray gun. Sprayability, as will be appreciated by those skilled in the art, is a function of the viscosity of a material.

Suitable substrates include, for example, a material such as, for example, a metal, a glass, a ceramic, a polymeric material, a leather, a cellulosic material, such as a wood material, a wood fiber-containing material, a wood composite, a wood laminate, a wood veneer, and combinations of any thereof. In this regard, when used herein, terms referring to materials such as a “metal,” a “glass,” a “ceramic,” a “wood,” and a “polymeric,” material are meant to include the various composite materials formed from these materials, in addition to those materials that have a substantially solid or pure composition. Other suitable substrates known to those of ordinary skill in the art may also be employed. In some embodiments, the substrate may be formed from a transparent material, such as a glass material, a polymeric material, and combinations thereof. As used herein, “transparent material” is meant to include semi-transparent, substantially transparent, and fully transparent materials.

For example, in certain embodiments, the compositions of the present disclosure may be deposited on the surface of the substrate or over a previously formed polymeric underlayer by any suitable coating process known to those of ordinary skill in the art, for example, by dip coating, spin coating, direct roll coating, reverse roll coating, curtain coating, spray coating, brush coating, electrostatic spray coating, and combinations of any thereof. The method and apparatus for applying the coating composition to the substrate is determined in part by the configuration and type of substrate material. In this regard, the coatings of the present disclosure may be deposited over the substrates set forth herein by these application methods. When applied over a plastic substrate, the compositions of the present disclosure are at least partially cured at a temperature below the thermal deformation temperature of the plastics. The coating compositions set forth herein may be deposited on the substrate as a monocoat, or employed in a multi-coat composite and deposited on the substrate. In this latter example, the coating composition provided herein may be incorporated into one or more of the layers of the composite coating such that the first layer may be deposited to at least partially coat the substrate and the second layer may be deposited to at least partially coat the first layer. As such, the present disclosure contemplates coating composites having at least two coating layers deposited from at least two coating compositions, in which at least one of the coating compositions may be the same or different from the other coating composition(s). In the latter example, the first coat can, but need not, be dried or cured in any manner, as provided below, before depositing the second coat thereover.

Following coating or depositing the coating composition on the substrate, the coating compositions of the present disclosure may be subject to various curing techniques known to those of ordinary skill in the art that are suitable to form a thin film. Curing may also be performed in a selective manner, depending on substrate configuration, wherein more than one form of curing technique may be performed in different areas of the substrate. For example, in certain embodiments of the present disclosure, any suitable ionizing and/or actinic radiation curable techniques, such as UV radiation, may be employed to cure the coating composition of the present disclosure.

The coating composition may be treated and cured, such as by conventional processes. For example, the coating compositions of the present disclosure can be radiation cured, such as by UV radiation, or at least partially dried by conventional processes, such as by evaporating water and solvent (if present) from the surface of the film by various methods, or by air drying at ambient (about 25° C.) or an elevated temperature for a period sufficient to dry the film. Suitable drying conditions will depend on the components of the coating composition on the ambient humidity, but in general a drying time of 30 minutes at a temperature of 60° C. may be adequate. The drying temperature can range from 40° C., and typically ranges from 40 to 80° C.

In addition, or as an alternative, to conventional air drying, the coating compositions of the present disclosure may be at least partially treated by means of ionizing radiation. As used herein, “ionizing radiation” means high energy radiation and/or the secondary energies resulting from conversion of this electron or other particle energy to neutron or gamma radiation, said energies being at least 30,000 electron volts and can range from 50,000 to 300,000 electron volts. While various types of ionizing irradiation are suitable for this purpose, such as X-ray, gamma and beta rays, the radiation produced by accelerated high energy electrons or electron beam devices may be employed in certain embodiments. The amount of ionizing radiation in rads for curing compositions according to the present disclosure can vary based on factors such as the components of the coating formulation, the thickness of the coating upon the substrate, the temperature of the coating composition and the like. Generally, a 1 mil (25 micrometer) thick wet film of a coating composition according to the present disclosure can be cured in the presence of oxygen through its thickness to a tack-free state upon exposure to from 0.5 to 5 megarads of ionizing radiation. The coating compositions of the present disclosure may also be cured in the presence of air, nitrogen, or CO₂.

“Actinic radiation” is light with wavelengths of electromagnetic radiation ranging from the ultraviolet (“UV”) light range, through the visible light range, and into the infrared radiation (“IR”) range. Actinic radiation which can be used to cure coating compositions of the present disclosure generally has wavelengths of electromagnetic radiation ranging from 150 to 2,000 nanometers (nm), and can range from 250 to 1,500 nm. UV radiation generally has wavelengths of electromagnetic radiation ranging from 150 to 400 nm. Examples of suitable ultraviolet light sources include mercury arcs, carbon arcs, low, medium or high pressure mercury lamps, swirl-flow plasma arcs and ultraviolet light emitting diodes. Suitable ultraviolet light-emitting lamps are medium pressure mercury vapor lamps having outputs ranging from 200 to 600 watts per inch (79 to 237 watts per centimeter) across the length of the lamp tube. Generally, a 1 mil (25 micrometer) thick wet film of a coating composition according to the present disclosure can be cured through its thickness to a tack-free state upon exposure to actinic radiation by passing the film at a rate of 5 to 1000 feet per minute (1.5 to 300 meters per minute) under four medium pressure mercury vapor lamps of exposure at 200 to 8000 millijoules per square centimeter of the wet film.

Three categories of IR are: near-IR (short wavelength) having a peak wavelength from 0.75 to 2.5 microns (“u”) (750 to 2500 nanometers); intermediate-IR (medium wavelength) having a peak wavelength from 2.5 to 4 u (2500 to 4000 nanometers); and far-IR (long wavelength) having a peak wavelength from 4 to 1000 u (4000 to 100,000 nanometers). Any combination or all of these categories of IR can be used to treat the coating. For example, in certain embodiments, the IR treatment may be applied to the coating composition at an intensity level in a range of 750 to 100,000 nanometers at a peak temperature range. In certain other embodiments, the IR treatment may be applied to the coating composition at an intensity level in the range of 5000 to 25000 nanometers at a peak temperature range.

The infrared radiation may be emitted by a plurality of emitters arranged in the interior treatment chamber. Each emitter may be a high intensity infrared lamp, such as a quartz envelope lamp having a tungsten filament. Useful short wavelength (0.76 to 2 micrometers), high intensity lamps include Model No. T-3 lamps such as are commercially available from General Electric Co., Sylvania, Phillips, Heraeus and Ushio and have an emission rate of between 75 and 100 watts per lineal inch at the light source. Medium wavelength (2 to 4 micrometers) lamps also can be used and are available from the same suppliers. Each medium wavelength emitter may be a medium intensity infrared lamp, such as a quartz envelope lamp having a carbon filter filament.

The number of emitters and their orientation may vary depending upon the desired intensity of energy to be emitted and the duration of the treatment. Depending upon such factors as the configuration and positioning of the substrate within the interior treatment chamber, the emitter lamps can be independently controlled by microprocessor such that the emitter lamps furthest from the surface of the substrate can be illuminated at a greater intensity than lamps closest to the surface of the substrate to provide uniform treatment.

Typically, the coating thickness of the coating composition after final drying and curing ranges from 0.2 to 2.0 mils (5.1 to 50.8 micrometers), and can range from 0.4 to 1.0 mils (10.2 to 25.4 micrometers).

Following curing, the coating composition exhibits certain properties, such as gloss and fingerprint or sebum resistance that are advantageous relative to known coating compositions. In particular, and as set forth in Table 1, below, the coating compositions set forth herein exhibit certain contact angles of water, squalene, and/or formamide that are beneficial for wetting of oil for improved transparency and cleanability. As provided herein, and in the Examples, embodiments of the present disclosure comprise a film-forming binder such that, when at least partially coated and cured on a substrate, comprise a contact angle of water ranging from 50 to less than 78, and a contact angle of squalene of less than 25. In certain embodiments, the contact angle with water ranges from 60 to 76, and in other embodiments, the contact angle with water ranges from 64 to 76. In certain embodiments, the contact angle with squalene is less than 20, and may be less than 15, in other embodiments the contact with squalene is less than 13, and may be less than or equal to 10, and in other embodiments, the contact angle of squalene is less than or equal to 9. In certain embodiments of the present disclosure, compositions set forth herein exhibit advantageous contact angles of formamide. For example, in certain embodiments, the coating compositions of the present disclosure comprises a contact angle with formamide that is greater than 40, and in other embodiments comprise a contact angle of formamide that is greater than 50.

Embodiments of the present disclosure can be employed as a coating on various substrates for use in numerous applications. As discussed herein, the substrates may be composites, or may be partially or entirely formed of various materials including, for example, a metal, a glass, a polymeric material, a cellulose-based material, such as a wood or wood composite, and combinations of any thereof. The substrates may be employed to form various devices, including, but not limited to, optical devices. As used herein the term “optical” means pertaining to or associated with light and/or vision. For example, according to various non-limiting embodiments disclosed herein, the optical element or device can be chosen from ophthalmic elements and devices, display elements and devices, windows, mirrors, and active and passive liquid crystal cell elements and devices. As used herein the term “ophthalmic” means pertaining to or associated with the eye and vision. Non-limiting examples of ophthalmic elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors. As used herein the term “display” means the visible or machine-readable representation of information in words, numbers, symbols, designs or drawings. Non-limiting examples of display elements and devices include screens, monitors, and security elements, such as security marks. As used herein the term “window” means an aperture adapted to permit the transmission of radiation therethrough. Non-limiting examples of windows include building windows and doors, automotive and aircraft transparencies, filters, shutters, and optical switches. As used herein the term “mirror” means a surface that specularly reflects a large fraction of incident light. Various wood or wood composite materials include, for example, furniture.

Any one of the devices set forth above may comprise a substrate comprising at least one coating layer formed from any one or more of the coating compositions set forth herein.

In certain embodiments, the cured coating has been found to exhibit improved gloss and haze properties, stain and fingerprint resistance, along with improve cleanability relative to those coating compositions that do not employ the compositions of the present disclosure. The cured coatings exhibit improved flow and leveling for water and squalene at the measured contact angles set forth herein. Within these contact angle ranges, it has been found that the gloss, anti-fingerprint, anti-smudging, and cleanability properties are particularly advantageous over conventional coating compositions. This is so because fingerprint residue over the coatings set forth herein spreads out as a thin layer (e.g. “wets out”) and appears more transparent rather than forming oil droplets that reflect and scatter light at different angles. Within the parameters set forth herein, the oil layer is less visible from most of the viewing angles and appears cleaner.

For example, for the alkoxide compositions provided herein that are substantially free of silicon additives, it has been found that by removing silicon from certain coating systems to form modified hardcoat formulations, such as UV cure modified sol-gel hardcoat formulations, an oleophilic cured surface has been developed that wherein contact angles of squalene have been reduced from 40 degrees to less than 10 degrees, providing a transparent hardcoat that is less susceptible to smudging, relative to commercially available hardcoats. In addition, it has been found that coating compositions set forth herein may be adapted for other types of oils that may be deposited on surfaces, such as plasticizers that condense on the inside of vehicle windshields and aircraft transparencies, for example, and may exhibit a reduced fogging and haze effect on glass substrates, which may be of particular benefit when the coating composition is deposited over devices such as glass windows and doors, for example.

In certain other embodiments that are employed in low gloss coating applications, for example, embodiments of the present invention exhibit anti-fingerprint characteristics wherein the resultant coating does not appear to “gloss-up” when handled. In like manner, in certain coating embodiments that are employed in high gloss coating applications, for example, embodiments of the present invention exhibit anti-fingerprint characteristics wherein the resultant coating does not appear to “gloss-down” when handled.

Coatings including the coating compositions of the present disclosure can provide primer/sealer surfacer, basecoat, topcoat, clearcoat, and monocoat coatings having one or more desirable properties, such as improved gloss, haze, fingerprint and sebum resistance, and/or improved cleanability over prior art coating compositions.

The invention will be further described by reference to the following examples. The following examples are merely illustrative of the invention and are not intended to be limiting. Unless otherwise indicated, all parts are by weight.

### EXAMPLES

### Ultraviolet Coating Formulations (Examples 1-7)

### Example 1

The base U.V. curable coating was formulated as follows:

In a 1 pint can, 110.15 grams of multi-charge composition was added under slow stirrer agitation. The multi-charge composition was prepared as follows:

| | pbw (grams) |
|---|---|
| Charge 1 | |
| VESTANAT T-1890L^{a} | 1212.75 |
| IONOL^{b} | 2.61 |
| Dibutyltin Dilaurate | 1.31 |
| Triphenyl Phosphite | 6.53 |
| Charge 2 | |
| SR-9003^{c} | 390.44 |
| Hydroxyl Ethyl Acrylate | 390.44 |
| Charge 3 | |
| 1,6 Hexanediol | 99.51 |
| Charge 4 | |
| SR-9003 | 339.51 |
| Charge 5 | |
| Butyl Acetate | 340.94 |

^{a}Polyisocyanate available from Degussa, now Evonik Degussa Corporation, Parsippany, NJ.
^{b}2,6-Di-t-butyl-p-cresol available from Shell Chemicals, Houston, TX.
^{c}Propoxylated Glycol Diacrylate available from Sartomer Company, Inc., Exton, PA.

Charge 1 was added to a 5 liter round bottom flask equipped with an air driven agitator stirring blade, thermocouple, and addition ports and heated to about 70° C. Charge 2 was added over about a 45 minute period while maintaining a temperature of 70°-75° C. Upon completion of Charge 2, the reaction was heated to 80° C. and held one hour. After the hold period, Charge 3 was added and the reaction held at about 80° C. until the isocyanate peak in the IR was gone. When the reaction was complete, Charges 4 and 5 were added. The reaction was cooled and discharged. The properties of the composition were: Solids content at 1 hour/110° C.: 71.6%; Weight Average Molecular Weight as measured by GPC: 4088.

To the multi-charge composition, 7.36 grams of DAROCUR 1173¹ was added under slow agitation. Next, 1.46 grams of IRGACURE 184² was added to the mixture under high agitation. 83.51 grams of SARTOMER 399³ was then added to the mixture under high agitation. Next, 44.22 grams of SARTOMER 454⁴ was added to the mixture under slow agitation. 1.51 grams of Genocure MBF⁵ was then added to the mixture under slow agitation. Slow mixing continued until the mixture became clear and homogeneous. ¹—Available from Ciba Specialty Chemicals Corporation, Tarrytown, N.Y.²—Available from Ciba Specialty Chemicals Corporation, Tarrytown, N.Y.³—Available from Sartomer Company, Inc., Exton, Pa.⁴—Available from Sartomer Company, Inc., Exton, Pa.⁵—Available from Rahn USA Corporation, Aurora, Ill.

### Example 2

33.33 grams of the composition of Example 1 was added to a 2 ounce jar. To this composition was added 1.55 grams of Isodecyl Acrylate⁶. The jar was sealed and shaken vigorously until the solution appeared homogeneous. ⁶—Available from Sartomer Company, Inc., Exton, Pa.

### Example 3

33.33 grams of the composition of Example 1 was added to a 2 ounce jar. To this composition was added 1.55 grams of Isobornyl Acrylate⁷. The jar was sealed and shaken vigorously until the solution appeared homogeneous. ⁷—Available from Sartomer Company, Inc., Exton, Pa.

### Example 4

33.33 grams of the composition of Example 1 was added to a 2 ounce jar. To this composition was added 1.55 grams of Stearyl Acrylate⁸. The jar was sealed and shaken vigorously. The solution did not appear perfectly clear. ⁸—Available from Sartomer Company, Inc., Exton, Pa.

### Example 5

33.33 grams of the composition of Example 1 was added to a 2 ounce jar. To this composition was added 1.55 grams of Octyl/Decyl Acrylate⁹. The jar was sealed and shaken vigorously. The solution did not appear perfectly clear. ⁹—Available from Sartomer Company, Inc., Exton, Pa.

### Example 6

33.33 grams of the composition of Example 1 was added to a 2 ounce jar. To this composition was added 0.30 grams of BYK 371010. The jar was sealed and shaken vigorously until the solution appeared clear. ¹⁰—Available from BYK-Chemie GmbH, Wesel, Germany.

### Example 7

33.33 grams of the composition of Example 1 was added to a 2 ounce jar. To this composition was added 0.25 grams of DAROCUR 1173¹¹. Next, 4.50 grams of Isobornyl Acrylate¹² was added. The jar was sealed and shaken vigorously until the solution appeared clear. ¹¹—Available from Ciba Specialty Chemicals Corporation, Tarrytown, N.Y.¹²—Available from Sartomer Company, Inc., Exton, Pa.

### Testing of Examples 1-7

The negative control was identified as sample XPC70031 U.V. High Gloss clearcoat system, available from PPG Industries, Pittsburgh, Pa. The substrate used was PC/ABS Cycloloy MC8002-701, available from Standard Plaque, Melvindale, Mich. The panels were wiped with isopropanol, and allowed to dry prior to spray application. Coating formulations were hand sprayed using a Binks 95 gun, with a line pressure of 50 psi, to a dry film build of approximately 0.45 mils, and were air dried for 5 minutes. The sprayed panels were then placed into an oven at 140° F. for 10 minutes. Then, the coated panels were removed from the oven and placed into a U.V. Cure unit with an energy intensity of approximately 550 mJ/cm and power intensity of approximately 400 mW/cm².

The panels were tested quantitatively using a digital goniometer to measure liquid contact angles of water, methylene iodide, formamide, and squalene. Table 1 reports the contact angle data collected. The panels were also tested qualitatively via smudging the panels with fingerprints, followed by wiping the panels with a non-abrasive dry paper towel, and observing the remaining fingerprint residue on the panel.

As set forth below in Table 1 The XPC70031 control sample and Example 6 had the worst remaining fingerprint residue, while Example 7 had the most improved resistance to fingerprints.

TABLE 1
CONTACT ANGLES TO DETERMINE
SOLID SURFACE TENSIONS
U.V. ANTIFINGERPRINT COATINGS

| | Contact | Contact | | |
|---|---|---|---|---|
| | Angle | Angle | Contact Angle | Contact Angle |
| Material | H₂O | Me₂I₂ | Formamide | Squalene |
| XPC70031 N₂ | 97.5 ± 0.4 | 58.8 ± 1.2 | 80.0 ± 0.3 | 40.9 ± 1.8 |
| (control) | | | | |
| XPC70031 Air | 90.6 ± 0.8 | 61.0 ± 0.9 | 72.9 ± 0.9 | 42.7 ± .04 |
| (control) | | | | |
| Ex. 3 N₂ | 71.6 ± 1.7 | 37.8 ± 0.6 | 56.3 ± 0.4 | 6.8 ± 0.5 |
| Ex. 3 Air | 64.1 ± 0.6 | 38.6 ± 2.4 | 35.3 ± 0.8 | 7.0 ± 0.4 |
| Ex. 7 N₂ | 73.3 ± 2.0 | 38.9 ± 0.9 | 60.5 ± 1.5 | 6.9 ± 1.0 |
| Ex. 7 Air | 74.6 ± 1.9 | 40.6 ± 1.2 | 43.3 ± 1.0 | 8.6 ± 0.4 |
| Ex. 6 N₂ | 97.1 ± 0.2 | 65.0 ± 2.7 | 83.3 ± 0.3 | 46.1 ± 0.4 |
| Ex. 6 Air | 85.4 ± 0.5 | 67.8 ± 0.4 | 73.1 ± 0.4 | 46.3 ± 0.4 |
| Ex. 1 N₂ | 71.7 ± 1.8 | 36.2 ± 0.6 | 52.0 ± 0.8 | 6.7 ± 0.3 |
| Ex. 1 Air | 61.8 ± 0.6 | 38.8 ± 0.9 | 46.0 ± 0.3 | 8.3 ± 0.5 |
| Ex. 4 N₂ | 82.9 ± 4.0 | 44.0 ± 0.6 | 68.2 ± 0.2 | 6.9 ± 0.4 |
| Ex. 2 Air | 74.8 ± 0.4 | 38.9 ± 1.6 | 49.8 ± 0.7 | 8.6 ± 0.5 |
| Ex. 2 N₂ | 76.5 ± 0.4 | 48.3 ± 0.6 | 69.8 ± 1.1 | 19.8 ± 0.8 |
| Ex. 2 Air | 77.2 ± 1.4 | 42.7 ± 1.1 | 57.0 ± 0.4 | 17.5 ± 0.6 |
| Ex. 5 N₂ | 86.3 ± 2.4 | 44.2 ± 2.1 | 69.0 ± 0.9 | 18.7 ± 1.3 |
| Ex. 5 Air | 95.5 ± 2.9 | 40.6 ± 0.9 | 84.5 ± 0.9 | 19.5 ± 1.1 |

### 2K Coating Formulation

### Example 8

In a 1 pint can, 176.92 grams of a multi-charge composition was added under slow stirrer agitation. The multi-charge composition was prepared as follows:

| | pbw (grams) |
|---|---|
| Charge 1 | |
| Butyl Acetate | 1186.0 |
| Charge 2 | |
| Isobornyl Methacrylate | 623.6 |
| Butyl Methacrylate | 779.6 |
| Hydroxyl Ethyl Methacrylate | 156.0 |
| Charge 3 | |
| Butyl Acetate | 296.3 |
| VAZO-67^{d} | 38.9 |
| Charge 4 | |
| Butyl Acetate | 98.8 |
| LUPEROX 575^{e} | 15.6 |

^{d}Available from DuPont de Nemours & Co, Wilmington, DE.
^{e}Available from Arkema Inc., Philadelphia, PA.

Charge 1 was added to a 5 liter round bottom flask equipped with an air driven agitator stirring blade, thermocouple, and addition ports and heated to reflux at about 126° C. At reflux, Charges 2 and 3 were added simultaneously and uniformly over a two hour period. Reflux conditions were maintained during the addition. After completion of Charges 2 and 3, Charge 4 was added over 60 minutes and then the reaction was allowed to hold for 60 minutes. The reaction was cooled and discharged from the reactor. The properties of the composition were: Solids content at 1 hour/110° C.: 48.97%; Weight Average Molecular Weight as measured by GPC: 8971; Viscosity as measured by Gardner Bubble tube: 0.83 seconds.

To the multi-charge composition, 0.10 grams of FOMREZ UL-24¹³ was added under slow agitation. Next, 50 grams of methyl amyl ketone¹⁴ was added under moderate agitation. 19.67 grams of xylene¹⁵ was then added and mixed under moderate agitation for approximately 1 minute. Next, 13.31 grams of DESMODUR N3300A¹⁶ was added and mixed under moderate agitation for approximately 1 minute. ¹³—Available from Momentive Performance Materials, Wilton, Conn.¹⁴—Available from Eastman Chemical Company, Kingsport, Tenn.¹⁵—Available from ExxonMobil Chemical Company, Houston, Tex.¹⁶—Available from Bayer MaterialScience LLC, Pittsburgh, Pa.

### Testing of Example 8

The negative control was identified as XPC60036 Durethane High Gloss clearcoat system, available from PPG Industries, Pittsburgh, Pa. The substrate used was PC/ABS Cycloloy MC8002-701, available from Standard Plaque, Melvindale, Mich. The panels were wiped with isopropanol, and allowed to dry prior to spray application. Coating formulations were hand sprayed using a Binks 95 gun, with a line pressure of 50 psi, to a dry film build of approximately 0.90 mils, and were air dried for 5 minutes prior to being oven baked. The sprayed panels were then placed into an oven at 180° F. for 30 minutes. The coated panels were removed from the oven and allowed to cool to room temperature.

The panels were tested semi-quantitatively to determine if water droplets would not bead on the surface and if squalene droplets would wet the surface versus the XPC60036 control. Squalene and water wet the surface of the composition of Example 8 better than the XPC60036 control. The panels were also tested qualitatively via smudging the panels with fingerprints, followed by wiping the panels with a non-abrasive dry paper towel, and observing the remaining fingerprint residue on the panel. The XPC60036 control had worse remaining fingerprint residue compared to the composition of Example 8.

### Sol-Gel Formulation

### Example 9

Diluted nitric acid solution was prepared by mixing 1.05 grams of 70% nitric acid with 7000.00 grams of DI water. In a clean reaction vessel, 326.4 grams of glycidoxypropyltrimethoxysilane and 186.0 grams of tetramethyl orthosilicate were mixed. The contents were cooled with an ice/water bath. When the temperature of the silane mixture in the reaction vessel reached to between 10-15° C., 80.5 grams of pre-diluted nitric acid solution was rapidly added with stirring to the reaction vessel. Increased temperature was observed as the result of the exothermal reaction. The ice/water bath was employed to keep the maximum reaction temperature between 15-20° C. The maximum temperature was reached 5-10 minutes after the addition of the acid solution. After the maximum temperature was reached, an additional 80.5 grams of pre-diluted nitric acid solution was added into the reaction vessel under stirring. The maximum temperature was reached 5-10 minutes after the second charge of the acid solution. The ice/water bath was employed to keep the maximum reaction temperature between 20-25° C. After the maximum temperature was reached, the water bath was removed and the reaction vessel was stirred at room temperature for 3 hours. After this time, the pH of the mixture was between 1.9-2.0. The pH was then adjusted to 5.5 by slowly adding a few drops of 25% tetramethylammonium hydroxide solution in methanol into the reaction vessel. After pH adjustment, 264.5 grams of DOWANOL PM (Dow Chemical Company, Midland, Mich.) and 12.1 grams of 50% triarylsulfonium hexafluorophosphate salts solution in propylene carbonate as cationic photo-initiator were added into the reaction vessel, and the reaction mixture was stirred for 10-20 minutes at room temperature.

In a separate container, 42.40 grams of NANOCRYL C 140 (Hanse Chemie USA Inc., Hilton Head Island, S.C.), 42.40 grams of DOWANOL PM and 590.00 grams of diacetone alcohol were mixed. This mixture was then added into the reaction vessel, and the reaction mixture was stirred for additional 30 minutes at room temperature. The coating solution was then filtered through a 0.45 micron nominal capsule filter in a single pass.

### Testing of Example 9

MAKROLON transparent polycarbonate substrate (Bayer AG, Leverkusen, Germany) was rinsed and wiped with 2-propanol. The coatings were spin applied on an un-primed substrate and cured with D bulb with UVA dosage of 6-8 J/cm² under air. The final dry film thickness was 3-5 μm. Surface contact angles of coated samples were measured as set forth in Table 2.

TABLE 2

| | |
|---|---|
| Contact angel | |
| (degree)¹⁷ | Easy to clean |

| | H₂O | Squalene | fingerprint¹⁸ |
|---|---|---|---|
| Example 9 | 58.2 | 8.0 | Yes |
| Standard | 76.8 | 32.9 | No |
| Hardcoat | | | |

¹⁷Average of 6 measurements at 3 different contact points.
¹⁸Fingerprint was applied and wiped off. Sample cleanness was visually evaluated.

### Anti-Fogging Testing

### Example 10

Several substrates were tested for anti-fogging properties relative to substrates coated with the compositions set forth herein. The substrates tested were: (1) glass with no coating; (2) glass coated with an isobornyl acrylate formulated into a high gloss clear coat which is UV cured (set forth in Example 7); (3) glass coated with an acrylic polyol that is cured with an isocyanate at 180° C. for 30 min (set forth in Example 8); and (4) glass coated with a fluorinated polysiloxane coating, commercially available as AQUAPEL glass treatment, from PPG Industries, Inc. The latter coating was included to show that the degree of hydrophobicity (gauged by the water contact angle) cannot be used to evaluate the effectiveness of the anti-fogging properties.

The testing was conducted to identify the lowest contact angle achievable, preferably less than 5 degrees for ‘super wetting’ of the material (either plasticizer or fingerprints) with the most spreading, which would lead to the least haze. Ideally, the surface energies of the coatings and the plasticizers/fingerprints would be measured and compared. Similar surface energies would demonstrate an optimum effect. The testing was meant to determine contact angle measurements and not surface energy measurements.

The clear polymeric coatings of substrates 2 and 3 were designed to have an oleophilic surface that causes fingerprints to wet out and visually disappear. The concept was to match the surface energy of the coatings with the surface energy of body oils. These coatings could be applied to cell phone housings and polycarbonate. In addition, this coating may have applications in glass for high fingerprint areas, such as sliding glass doors, or may be adapted for other types of oils that mar glass surfaces, such as the plasticizers that condense on the inside of automotive windshields.

An objective of this testing was to determine how the coatings perform in reducing the fogging characteristics of interior automotive materials on the automotive windshield. It is believed that such a coating would positively affect the safety of the driver, as the haze attributed to organic materials that condense on the windshield would be minimized and, in direct lighting conditions, provide the driver with a much clearer view. The primary source of the organics that condense on the windshield is plasticizers and low molecular weight materials that are formulated in the interior parts of the automobile. For the purposes of testing, dioctylphthalate (DOP) was chosen because it is a very common plasticizer used in the vinyl parts inside the automobile and it is also one of the leading materials that contribute to fogging.

Contact angle measurements indicate that the DOP wets out best on anti-fingerprint Coating 2 (Example 7) and Coating 3 (Example 8), with Coatings 3 wetting out better than Coating 2. Ideally, a contact angle that is less than or equal to 5 degrees is preferred as this would result in ‘super wetting’ of the material with the most spreading and the least haze. The average contact angle for water and for DOP for each of the coatings is provided in the Table 3, below:

TABLE 3

| | ave contact angle | ave contact angle of |
|---|---|---|
| Substrate | of water (deg) | dioctylphthalate (deg) |
| (1) | 28.2 ± 2.4 | 24.0 ± 2.4 |
| (2) | 82.8 ± 5.5¹⁹ | 12.4 ± 3.6 |
| (3) | 87.6 ± 0.4¹⁹ | 8.5 ± 1.0 |
| (4) | 98.1 ± 5.7²⁰ | 71.0 ± 1.4 |

¹⁹The contact angles of water were measured 24 hours after the samples were prepared. Because of possible contaminant pick up during the transfer on the surface prior to the DOP studies, the expectation is that the average contact angle of water would be less than those specified in Table 3 if the samples were tested more closely following their preparation.
²⁰The contact angles of water for AQUAPEL have been found to range from 95 to 120 degrees, with an average between 110 to 115 degrees.

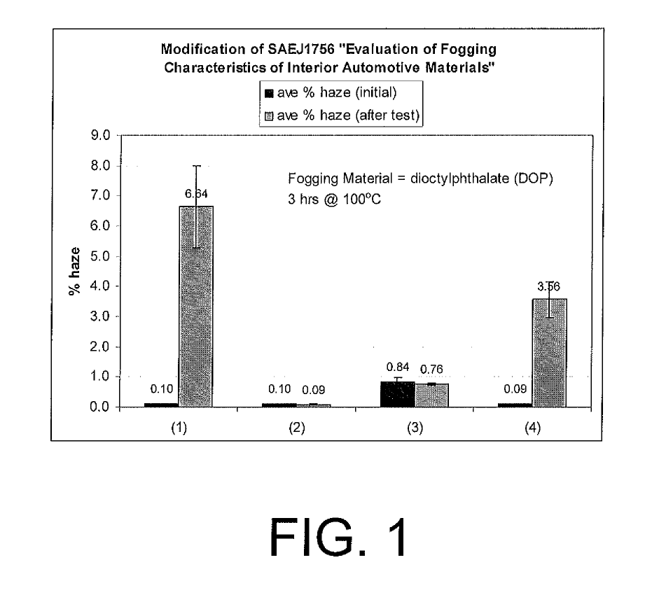

SAE J1756, “Fogging Characteristics of Interior Automotive Materials”, incorporated by reference herein in its entirety, was identified as a standard test method for evaluating the fogging characteristics of interior automotive materials. Generally, the specifications for the test method are designated by the automobile manufacturer. The test was modified as follows. The 3 inch×3 inch coated glass samples and 8 ounce wide mount jars (2⅞ inch diameter) were cleaned with deionized water and 50 percent isopropyl alcohol in water. The samples were placed face down over the glass jars containing the dioctyl phthalate on a hotplate and the temperature was held at 100° C. for 3 hours. After 3 hours the samples were removed and allowed to equilibrate to ambient temperature and haze data was collected. The percent haze was monitored using a BYK Gardner HAZEGARD Plus haze meter before and after testing. The results are given in the Table 4, below, as well as graphically in FIG. 1.

TABLE 4

| | (1) | (2) | (3) | (4) |
|---|---|---|---|---|
| before test haze | 0.10 | 0.10 | 0.96 | 0.10 |
| readings | 0.11 | 0.09 | 0.97 | 0.10 |
| | 0.10 | 0.10 | 0.83 | 0.07 |
| | 0.09 | 0.12 | 0.71 | 0.10 |
| | | | 0.73 | |
| ave % haze (initial) | 0.10 | 0.10 | 0.84 | 0.09 |
| Stdev | 0.01 | 0.01 | 0.12 | 0.02 |
| after test haze | 6.38 | 0.10 | 0.72 | 3.62 |
| readings | 5.68 | 0.10 | 0.82 | 4.27 |
| | 5.85 | 0.09 | 0.72 | 3.58 |
| | 8.63 | 0.07 | 0.78 | 2.78 |
| ave % haze (after test) | 6.64 | 0.09 | 0.76 | 3.56 |
| Stdev | 1.36 | 0.01 | 0.05 | 0.61 |
| Δ % haze | 6.54 | −0.01 | −0.08 | 3.47 |
| Stdev | 1.36 | 0.01 | 0.05 | 0.61 |

As set forth in Table 4 and in FIG. 1, there was essentially no change in the percent haze on the anti-fingerprint coatings (2 and 3), while the haze increased from approximately 0.10% to 6.63% for the clear glass (1) and from approximately 0.10% to 3.56% for the fluorinated polysiloxane coated glass (4). This result demonstrates that the anti-fingerprint coatings do have anti-fogging characteristics.

It will be appreciated by those skilled in the art that changes could be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

We claim:

1. A coating composition comprising a film-forming binder and, when at least partially coated and cured on a substrate, comprising:
(a) a contact angle with water ranging from 50 to less than 78; and
(b) a contact angle with squalene of less than 25.

2. The coating composition of claim 1, wherein the contact angle with water ranges from 60 to 76.

3. The coating composition of claim 1, wherein the contact angle with water ranges from 64 to 76.

4. The coating composition of claim 1, wherein the contact angle with squalene is ≦15.

5. The coating composition of claim 1, wherein the contact angle with squalene is ≦13.

6. The coating composition of claim 1, wherein the contact angle of water ranges from 60 to 76 and the contact angle of squalene is ≦9.

7. The coating composition of claim 1, wherein the coating composition further comprises a contact angle with formamide that is greater than 40.

8. The coating composition of claim 7, wherein the contact angle with formamide is greater than 50.

9. The coating composition of claim 1, wherein the binder is selected from the group consisting of a thermosetting acrylic polymer, a thermoplastic acrylic polymer, a radiation curable polymer, an alkoxide of the general formula RₓM(OR′)_{z-x}, where R is an organic radical, M is selected from the group consisting of silicon, aluminum, titanium, zirconium and mixtures of any thereof, R′ is selected from the group consisting of low molecular weight alkyl radicals, z is the valence of M, and x is less than z and may be zero except when M is silicon, and combinations of any thereof.

10. The coating composition of claim 9, wherein Mw of the thermoplastic acrylic polymer is greater than 8,000.

11. The coating composition of claim 1, wherein the binder comprises at least one (meth)acrylate with polycycloalkyl groups or alkyl groups having 10 or more carbons.

12. The coating composition of claim 11, wherein the at least one (meth)acrylate with polycycloalkyl groups or alkyl groups having 10 or more carbons is present in the binder in an amount of at least 5 percent by weight, based on the total weight of the resin solids.

13. The coating composition of claim 12, wherein the binder comprises at least one of isobornyl acrylate and isobornyl methacrylate.

14. The coating composition of claim 1, wherein the binder comprises at least one alkyl methacrylate having from 1 to 20 carbon atoms in the alkyl group.

15. The coating composition of claim 14, wherein the at least one of alkyl methacrylate having from 1 to 20 carbon atoms in the alkyl group is present in an amount of at least 20 percent by weight, based on the total weight of the resin solids.

16. The coating composition of claim 14, wherein the at least one alkyl methacrylate having from 1 to 20 carbon atoms in the alkyl group is selected from the group consisting of methyl methacrylate, ethyl methacrylate, propyl methacrylate, isopropyl methacrylate, butyl methacrylate, isobutyl methacrylate, tert-butyl methacrylate, 2-ethylhexyl methacrylate, lauryl methacrylate, cyclohexyl methacrylate, 3,3,5-trimethylcyclohexyl methacrylate, hydroxyalkyl methacrylates, oxirane functional methacrylates, and carboxylic acid functional methacrylates.

17. The coating composition of claim 1, wherein the binder comprises:
at least one of alkyl methacrylate having from 1 to 20 carbon atoms in the alkyl group; and
at least one (meth)acrylate with polycycloalkyl groups or alkyl groups having 10 or more carbons.

18. The coating composition of claim 1, wherein the coating composition is substantially silicon free.

19. A coated substrate comprising at least one coating layer, the at least one coating layer comprising the coating composition of claim 1.

20. The substrate of claim 19, wherein the substrate is a material selected from the group consisting of a metal, a glass, a polymeric material, a cellulose-based material, and combinations of any thereof.

21. The substrate of claim 19, wherein the substrate is a transparent material selected from the group consisting of a glass material, a polymeric material, and combinations thereof.

22. A device having at least one substrate, the substrate at least partially coated with at least one coating layer comprising the coating composition of claim 1.

23. A film-forming coating composition, comprising:
a film-forming binder formed from at least one of a blend of components and reactants, comprising:
at least one alkyl methacrylate having from 1 to 20 carbon atoms in the alkyl group present in an amount of at least 20 percent by weight, based on the total weight of the resin solids; and
at least one (meth)acrylate with polycycloalkyl groups or alkyl groups having 10 or more carbons present in the composition in an amount of at least 5 percent by weight, based on the total weight of the resin solids,
wherein, when at least partially coated and cured on a substrate, the coating composition comprises:
(a) a contact angle with water ranging from 50 to less than 78; and
(b) a contact angle with squalene of less than 25.

24. The film-forming coating composition of claim 23, wherein the at least one (meth)acrylate with polycycloalkyl groups or alkyl groups having 10 or more carbons is present in the composition in an amount of at least 20 percent by weight, based on the total weight of the resin solids.

25. The film-forming coating composition of claim 23, wherein the at least one (meth)acrylate with polycycloalkyl groups or alkyl groups having 10 or more carbons is present in the composition in an amount of at least 30 percent by weight, based on the total weight of the resin solids.

26. The film-forming coating composition of claim 23, wherein the at least one (meth)acrylate with polycycloalkyl groups or alkyl groups having 10 or more carbons is present in the composition in an amount of at least 40 percent by weight, based on the total weight of the resin solids.

27. The film-forming coating composition of claim 23, wherein the at least one (meth)acrylate with polycycloalkyl groups or alkyl groups having 10 or more carbons is present in the composition in an amount of at least 50 percent by weight, based on the total weight of the resin solids.

28. The film-forming coating composition of claim 23, wherein the coating composition comprises a contact angle with water ranging from 60 to 76.

29. The film-forming coating composition of claim 23, wherein the coating composition comprises a contact angle with squalene of ≦15.

30. The film-forming coating composition of claim 23, wherein the coating composition comprises a contact angle with squalene of ≦13.

31. A substrate comprising at least one coating layer, the at least one coating layer comprising the coating composition of claim 23.

32. The substrate of claim 31, wherein the substrate is a material selected from the group consisting of a metal, a glass, a polymeric material, a cellulose-based material, and combinations of any thereof.

33. The substrate of claim 31, wherein the substrate is a transparent material selected from the group consisting of a glass material, a polymeric material, and combinations thereof.

34. A device having at least one substrate, the substrate at least partially coated with at least one coating layer comprising the coating composition of claim 23.

35. A thermosetting acrylic polymer coating composition, comprising:
a film-forming binder having functional groups and formed from reactants, comprising:
at least one alkyl methacrylate having from 1 to 20 carbon atoms in the alkyl group present in an amount ranging from 10 to 40 percent by weight, based on the total weight of the acrylic polymer;
at least one (meth)acrylate with polycycloalkyl groups or alkyl groups having 10 or more carbons present in the composition in an amount ranging from 30 to 65 percent by weight, based on the total weight of the acrylic polymer; and
a crosslinking agent having functional groups capable of reacting with the functional groups of the binder.

36. A high molecular weight thermoplastic acrylic polymer coating composition, comprising:
a film-forming binder formed from reactants, comprising:
at least one of alkyl methacrylate having from 1 to 20 carbon atoms in the alkyl group present in an amount of at least 20 percent by weight, based on the total weight of the acrylic polymer; and
at least one (meth)acrylate with polycycloalkyl groups or alkyl groups having 10 or more carbons present in the composition in an amount ranging from 40 to 70 percent by weight, based on the total weight of the acrylic polymer.

37. The coating composition of claim 36 wherein Mw of the thermoplastic acrylic polymer is greater than 8,000.

38. A radiation curable coating composition formed in the presence of monomeric components, comprising:
at least one (meth)acrylate with polycycloalkyl groups or alkyl groups having 10 or more carbons present in the composition in an amount of at least 5 percent by weight, based on the total weight of the resin solids;
at least one of one multifunctional acrylate; and
a radiation cure initiator.

39. The coating composition of claim 38, wherein the coating composition is UV radiation curable.

40. The coating composition of claim 38, wherein the coating composition comprises at least 30 percent by weight solids.

41. A device comprising:
a substrate comprising at least one coating layer, the at least one coating layer formed from a coating composition, comprising:
an alkoxide of the general formula RₓM(OR′)_{z-x}, where R is an organic radical, M is selected from the group consisting of silicon, aluminum, titanium, zirconium and mixtures of any thereof, R′ is selected from the group consisting of low molecular weight alkyl radicals, z is the valence of M, and x is less than z and may be zero except when M is silicon;
wherein, when at least partially coated and cured on the substrate, the coating composition comprises a contact angle with squalene of ≦20.
